(19) United States
(12) Patent Application Publication
(10) Pub. No.: US 2007/0164461 A1
(43) Pub. Date: Jul. 19, 2007

(54) Breathable liquid-volatilizing device

(76) Inventor: Nein-Jung Wang, Sanchong City (TW)

Correspondence Address: HDSL, 4331 STEVENS BATTLE LANE, FAIRFAX, VA, 22033, US

(21) Appl. No.: 11/331,213

(22) Filed: Jan. 13, 2006

(51) Int. Cl. G05D 23/13; B01D 47/00

(52) U.S. Cl. 261/101; 236/12.14; 261/103

(57) ABSTRACT

A breathable liquid-volatizing device for maintaining the relative humidity in a space includes a rectangular closed casing. The casing is hollow and provided with an inlet port. A plurality of parallel draining grooves are provided on the bottom plate of the casing. A plurality of breathable plates are provided under the casing corresponding to the positions of the draining grooves. A water-absorbing layer is provided in the interior of the breathable plate. A film having tiny pores is covered on the outer surface of the water-absorbing layer. When the liquid water is poured into the closed casing through the inlet port, it flows into the breathable plate via the draining grooves provided on the bottom plate and is absorbed by the water-absorbing layer. With the pressure difference between the inside and the outside of the film, the liquid water can be pressed out of the tiny pores and transformed into vapor molecules, thereby to maintain the density of the vapor molecules in the air.

### BACKGROUND OF THE INVENTION

1. Field of the Invention

The present invention relates to a liquid-volatilizing device, and in particular to a liquid-volatilizing device capable of maintaining the relative humidity in a room.

2. Description of Prior Art

The rapid development of technology has already brought people a lot of improvements in the quality of life. Various electronic products have a close relationship with our daily life and bring much convenience to our life. Especially in different seasons, the technology has solved the problems caused by the change of seasons. For example, in a burning hot summer, the earlier electric fans and the later-developed air conditioners have already made our life more comfortable.

The generally household air conditioner is of air-cooling type, which in principle employs the heat-absorbing and heat-dissipating properties of a refrigerant between a compressed state and an expanded state. First, the indoor air is taken into the air conditioner and then carries out the heat exchange with the condenser therein, so that the temperature of the air can be lowered. After this, the air with lowered temperature is blown back to the room. With such repeated cycles and the circulation of the air, the temperature of the air can be lowered, and thus the water molecules inherently contained in the air will be condensed and transformed into water droplets in the air conditioner due to the rapid lowering of the temperature of the air. As a result, when the air conditioner is in operation, the condensed water droplets are usually drained away to the outside of the room.

However, since the air conditioner continuously takes the water molecules inherently contained in the air of the closed room to lower its temperature, and then the dried air with lowered temperature is blown to the interior of the room, the water molecules inherently contained in the room are gradually condensed in the air conditioner to become water droplets and then drained outside. As a result, the number of the water molecules in the air is continuously decreasing, and, in turn, the relative humidity in the room is also decreased. Therefore, with regard to people who stay in a room with an air conditioner running for a long time, the moisture of the human body will be rapidly evaporated owing to the decrease in the water molecules in the air, causing the dryness of eyes and skin and having some harmful influences on human's healthy.

Further, the way of draining the condensed water out of the air conditioner is mostly by using an outlet port outside the air conditioner and a drainpipe connected to the outlet port. Then, the drainpipe is fixed to the outer wall of a building. When the air conditioner is in operation, the condensed water can be smoothly drained out. However, not only such a drainpipe damages the outer appearance of the building, but also the material of the drainpipe will be deteriorated due to the long-term irradiation of sunlight, causing the breakage of the drainpipe. When the drainpipe is damaged or fallen off, the condensed water will drop directly. If the droplets hit the pedestrians or other air conditioner, window or canopy, it is irritating and causing troublesome noises. Although some manufactures propose an air conditioner without the dropping of the condensed droplets, in such kind of air conditioner, the condensed water is collected and pumped back to the interior of the air conditioner by a larger fan, and then evaporated by a heat pipe inside the air conditioner. However, the pumping of the condensed water back to the interior of the air conditioner will accommodate dust and even mud after a long-term use. Thus, other problems, such as cleaning or maintaining are caused.

No matter what kinds of the air conditioners in which the condensed water drops or not, the number of water molecules contained in the air of the closed room will be inevitably decreased. Therefore, it is an important issue to solve the influence on the indoor humidity caused by the air conditioner.

### SUMMARY OF THE INVENTION

In view of the above, the present invention is to provide a breathable liquid-volatilizing device capable of maintaining the relative humidity in a space. With a film having tiny pores on a breathable plate, the absorbed liquid water is pressed out of the tiny pores on the film due to the pressure difference between the inside and the outside of the film, so that the density of the vapor molecules in the space can be maintained.

Another, the present invention is to provide a breathable liquid-volatilizing device. The condensed water is recycled to the inside of the air conditioner. Then, the condensed water is transformed into vapor molecules diffusing outward and dissipated into the space due to the pressing action caused by the pressure difference between the inside and the outside of the film covered on the breathable plate. As a result, the density of the vapor molecules in the space can be maintained, which solves the problems in environmental prevention caused by the condensed droplets of the air conditioner.

### BRIEF DESCRIPTION OF THE DRAWINGS

FIG. 1 is an exploded perspective view of the present invention;

FIG. 2 is a cross-sectional view showing the assembling of the present invention;

FIG. 3 is a schematic view showing the connection in which the present invention is applied to an air conditioner;

FIG. 4 is a cross-sectional view showing a second embodiment of the present invention;

FIG. 5 is a cross-sectional view showing a third embodiment of the present invention;

FIG. 6 is a cross-sectional view showing a fourth embodiment of the present invention;

### DETAILED DESCRIPTION OF THE INVENTION

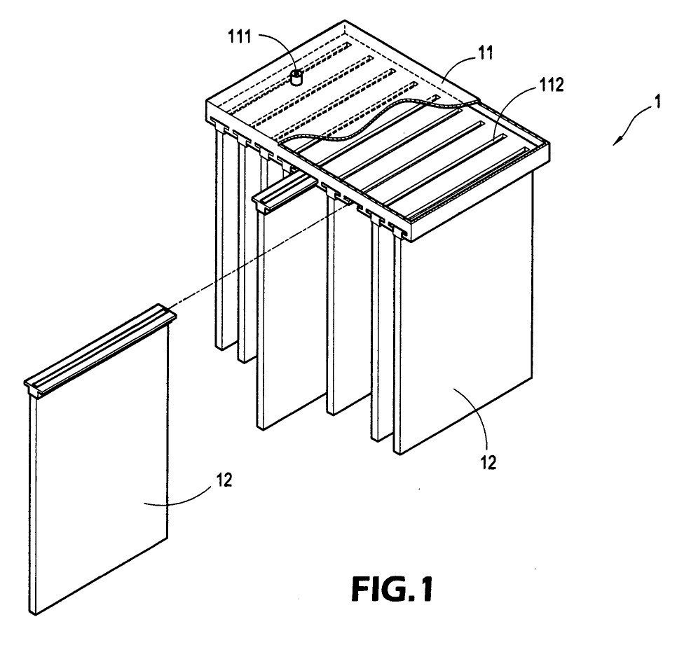

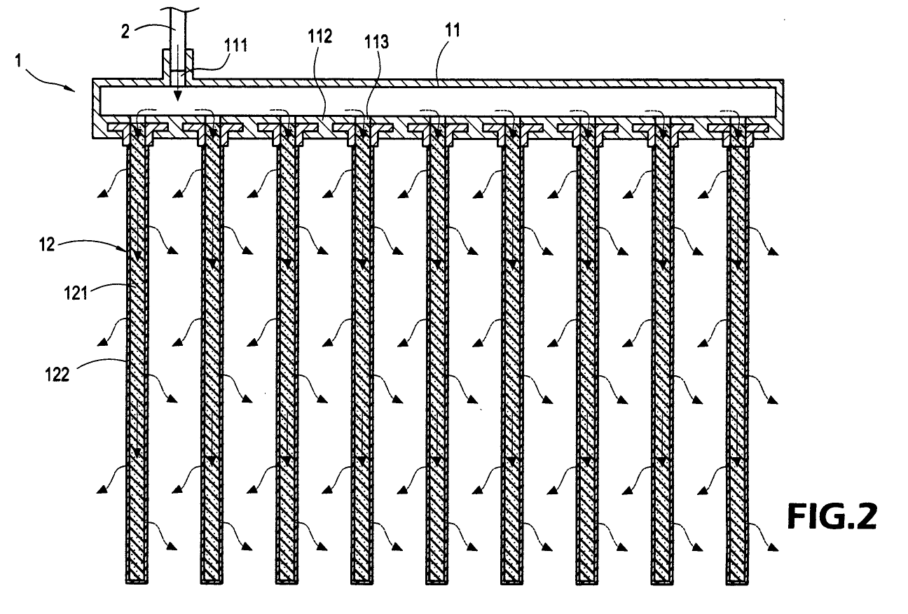

FIG. 1 is an exploded perspective view of the present invention. As shown in FIG. 1, a breathable liquid-volatilizing device 1 of the present embodiment has a rectangular casing 11. The casing 11 is hollow and closed for accommodating the liquid water. An inlet port 111 is provided on the casing 11, and a plurality of parallel draining grooves 113 are provided on a bottom plate 112 of the closed casing 11. A plurality of parallel breathable plates 12 are vertically provided beneath the bottom plate 112 of the casing 11. One side of the breathable plate 12 is connected to the draining grooves 113 provided on the bottom plate 112. With reference to FIG. 2, the interior of the breathable plate 12 is provided with a water-absorbing layer 121 made of water-absorbing materials, such as active carbon fibers, nonwovens or swabs. One side of the water-absorbing layer 121 is directly connected to the draining grooves 113, such that the liquid water can be drained into the water-absorbing layer via the draining grooves 113. Both surfaces of the breathable plate 12 and the other side not connecting to the draining grooves 113 are covered with a layer of film 122. The film is a waterproof and breathable. A plurality of tiny pores are distributed on the surface of the film 122. As a result, when the liquid water flows from a volume trough 11 into each breathable plate 12 along the plurality of the draining grooves 113, the liquid water can be absorbed by the water-absorbing layer 121 of the breathable plate 12 until a predetermined amount of the liquid water has been absorbed. The liquid water is pressed out of the tiny pores due to the pressure difference between the inside and outside of the film 122, such that the liquid water is transformed into vapor molecules and dissipated into the air to compensate for the insufficient amount of the vapor molecules. As a result, the relative humidity in the space can be maintained.

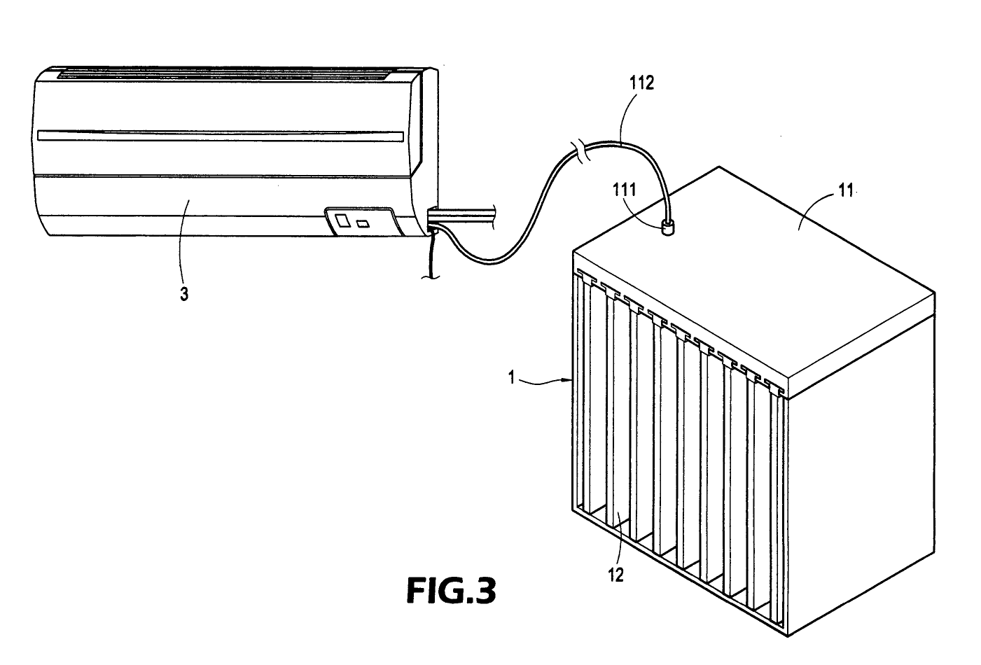

FIG. 3 is a schematic view showing the connection in which the present invention is applied to an air conditioner. As shown in FIG. 3, the breathable liquid-volatilizing device 1 is connected to a drain hole for the condensed water of the air conditioner 3 via a pipe 2. When the air conditioner 3 is in operation, the vapor molecules inherently contained in the air are condensed to become the liquid water by the refrigerant. The condensed water is poured into the casing 11 of the breathable liquid-volatizing device 1 through the drain hole connected to the pipe 2. Then, the liquid water flows into each breathable plate 12 and is absorbed by the water-absorbing layer 121 in the breathable plate 12 until a predetermined amount of the liquid water has been absorbed. With the waterproof and vapor-permeable characteristics of the film 122 covered on the surface of the breathable plate 12, the condensed water can be pressed out of the tiny pores of the film 122 and then dissipated to the air due to the pressure difference between the inside and the outside of the film 122. The impurities contained in the condensed water can be separated and left in the water-absorbing layer 121. As a result, the relative humidity in the air can be maintained.

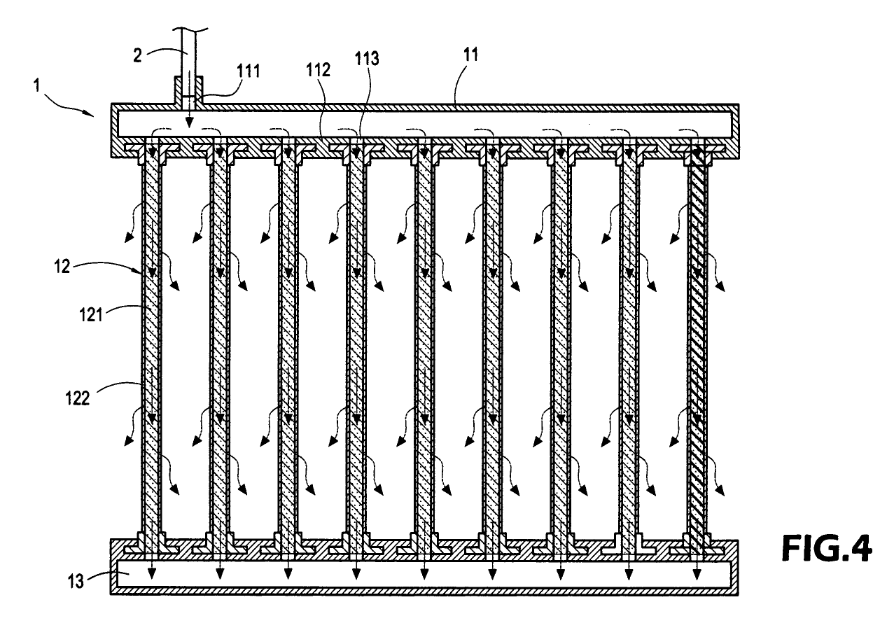

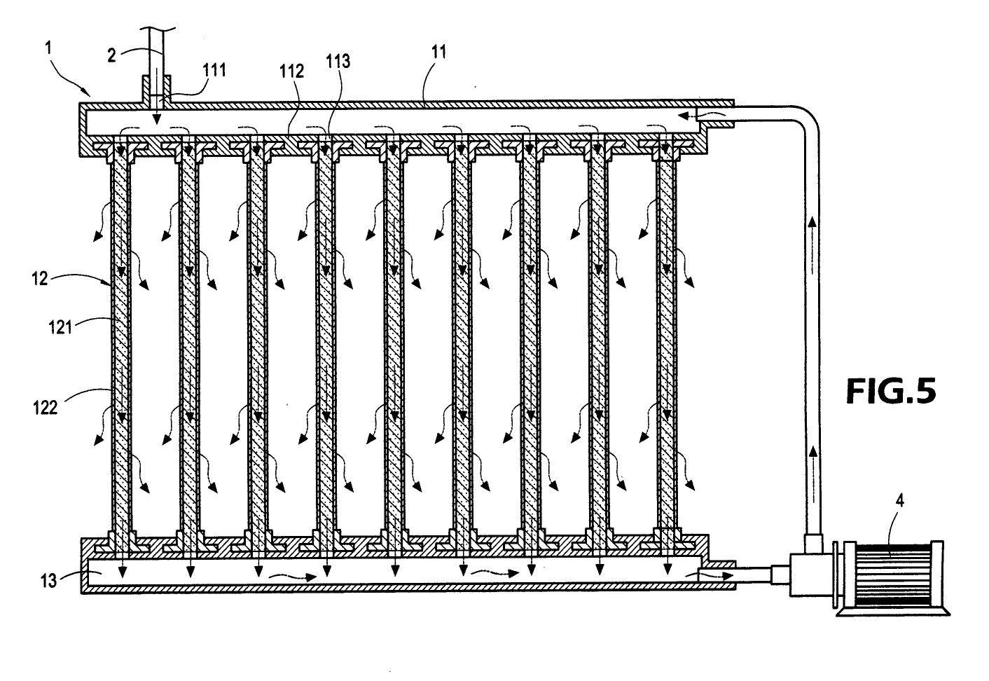

FIG. 4 is a cross-sectional view showing a second embodiment of the present invention. As shown in FIG. 4, a recycling box 13 is further provided under the plurality of parallel breathable plates 12. The recycling box is connected to the other side of the breathable plate 12. Also, the same side of the water-absorbing layer 121 is directly connected to the recycling box 13. After the water-absorbing layer 121 of the breathable plate 12 has absorbed the liquid water via the draining grooves 113 up to a predetermined amount of water, the liquid water can be pressed out of the tiny pores due to the pressure difference between the inside and the outside of the film 122. If the water-absorbing layer 121 absorbs too much liquid water and becomes saturated, the excess liquid water will flow downwardly along the water-absorbing layer 121 until flowing into the recycling box 13 under the breathable plate 12. Thus, the excess liquid water can be recycled and stored. Further, a pipe is connected between the recycling box 13 and the casing 11. A pump 4 can be further provided between the casing 11 and the recycling box 13. As shown in FIG. 5, the excess liquid water recycled in the recycling box 13 can be pumped back into the casing 11. At the time, the liquid water can be transformed into the vapor molecules and dissipated into the air via the breathable plate 12.

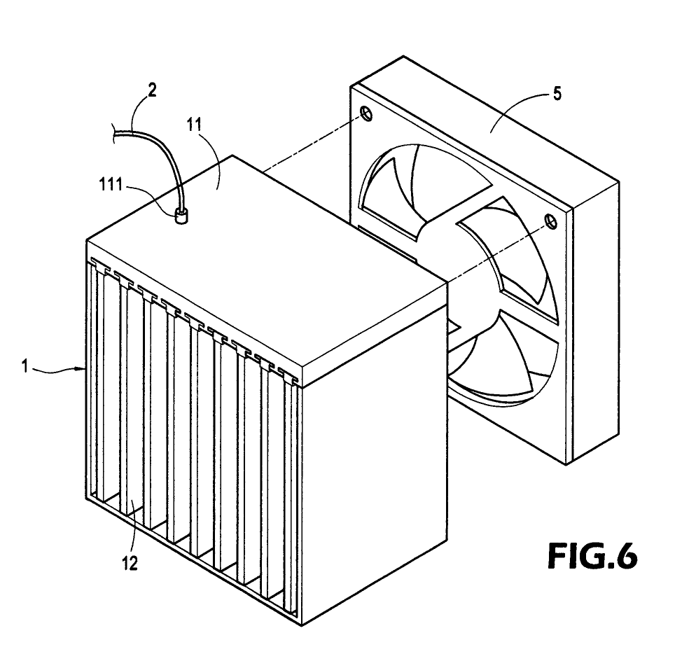

FIG. 6 is a cross-sectional view showing a fourth embodiment of the present invention. A fan 5 is further provided in the rear of the breathable liquid-volatizing device 1. The airflows produced by the fan 5 pass through the intervals formed between the plurality of parallel breathable plates 2. As a result, the liquid water is pressed out of the film 122 on the breathable plate 12 and then transformed into vapor molecules, the thus-formed vapor molecules are rapidly blown to a farther place with the blowing of the fan 5. Therefore, the density of the vapor molecules around the breathable plate 12 can be lowered, facilitating the rate of transforming the liquid water into the vapor molecules in the breathable plate 12. In this way, the relative humidity in the air can be maintained.

Although the present invention has been described with reference to the foregoing preferred embodiments, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A breathable liquid-volatizing device, comprising:
a hollow casing provided with at least one draining grooves on the bottom surface thereof; and
a breathable plate provided under the casing and having a water-absorbing layer, wherein the surface of the water-absorbing layer is covered with a film, and the surface of the film is provided with a plurality of tiny pores.

2. The breathable liquid-volatizing device according to claim 1, wherein the casing is closed.

3. The breathable liquid-volatizing device according to claim 2, wherein the casing is further provided with an inlet port.

4. The breathable liquid-volatizing device according to claim 1, wherein the film is waterproof and vapor-permeable.

5. The breathable liquid-volatizing device according to claim 1, wherein water-absorbing layer is made of any one of the active carbon fiber, nonwoven or swab.

6. The breathable liquid-volatizing device according to claim 1, wherein one side of the breathable plate is connected to the draining grooves.

7. The breathable liquid-volatizing device according to claim 1, wherein a recycling box is further provided under the plurality of breathable plates.

8. The breathable liquid-volatizing device according to claim 7, wherein the recycling box is connected to the other side of the breathable plate.

9. The breathable liquid-volatizing device according to claim 7, wherein the recycling box is provided with a pipe connected to the casing.

10. The breathable liquid-volatizing device according to claim 9, further comprising a pump.

11. The breathable liquid-volatizing device according to claim 1, further comprising a fan.
